(19) United States
(12) Patent Application Publication
(10) Pub. No.: US 2013/0268176 A1
(43) Pub. Date: Oct. 10, 2013

(54) EXHAUST GAS RECIRCULATION CONTROL SYSTEMS AND METHODS FOR LOW ENGINE DELTA PRESSURE CONDITIONS

(71) Applicants: B. Jerry Song, Novi, MI (US); Gregory J. York, Fenton, MI (US); Jon C. Wasberg, Davison, MI (US); Eric M. Hall, Rochester Hills, MI (US)

(72) Inventors: B. Jerry Song, Novi, MI (US); Gregory J. York, Fenton, MI (US); Jon C. Wasberg, Davison, MI (US); Eric M. Hall, Rochester Hills, MI (US)

(73) Assignee: GM Global Technology Operations LLC, Detroit, MI (US)

(21) Appl. No.: 13/440,570

(22) Filed: Apr. 5, 2012

(51) Int. Cl. F02D 28/00; F02D 41/26

(52) U.S. Cl. 701/102

(57) ABSTRACT

A partial pressure determination module: determines a first partial pressure of oxygen in an intake manifold of an engine based on an output of a first oxygen sensor measuring oxygen in the intake manifold; and determines a second partial pressure of oxygen in an exhaust system based on an output of a second oxygen sensor measuring oxygen in the exhaust system. A concentration determination module: determines a concentration of oxygen in the intake manifold based on the first partial pressure and an intake manifold; and determines a concentration of oxygen in the exhaust system based on the second partial pressure. A flowrate determination module determines a mass flowrate of exhaust gas recirculation (EGR) based on the concentration of oxygen in the intake manifold and the concentration of oxygen in the exhaust system. An actuator control module controls an engine operating parameter based on the mass flowrate of EGR.

### FIELD

The present disclosure relates to internal combustion engines and, more specifically, to exhaust gas recirculation control systems and methods.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An engine combusts air and fuel to generate torque. Air flows into the engine through an intake system. The intake system includes a throttle valve and an intake manifold. Fuel is provided by one or more fuel injectors. The engine outputs torque to a transmission. The transmission transfers torque to one or more wheels. Exhaust resulting from combustion is expelled from the engine to an exhaust system.

An exhaust gas recirculation (EGR) system re-circulates exhaust back to the intake manifold or another location in the intake system. For exhaust to flow back to the intake manifold, pressure within the exhaust system must be greater than a pressure within the intake manifold. The EGR system maybe controlled such that a target mixture of exhaust, air, and fuel is provided to each cylinder. The engine may not operate as intended when the target mix is not maintained.

### SUMMARY

A partial pressure determination module: determines a first partial pressure of oxygen in an intake manifold of an engine based on an output of a first oxygen sensor measuring oxygen in the intake manifold; and determines a second partial pressure of oxygen in an exhaust system based on an output of a second oxygen sensor measuring oxygen in the exhaust system. A concentration determination module: determines a concentration of oxygen in the intake manifold based on the first partial pressure and an intake manifold; and determines a concentration of oxygen in the exhaust system based on the second partial pressure. A flowrate determination module determines a mass flowrate of exhaust gas recirculation (EGR) based on the concentration of oxygen in the intake manifold and the concentration of oxygen in the exhaust system. An actuator control module controls an engine operating parameter based on the mass flowrate of EGR.

An engine control method for a vehicle includes: determining a first partial pressure of oxygen in an intake manifold of an engine based on an output of a first oxygen sensor measuring oxygen in the intake manifold; determining a second partial pressure of oxygen in an exhaust system based on an output of a second oxygen sensor measuring oxygen in the exhaust system; determining a concentration of oxygen in the intake manifold based on the first partial pressure and an intake manifold; determining a concentration of oxygen in the exhaust system based on the second partial pressure; determining a mass flowrate of exhaust gas recirculation (EGR) based on the concentration of oxygen in the intake manifold and the concentration of oxygen in the exhaust system; and controlling an engine operating parameter based on the mass flowrate of EGR.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A and 1B are functional block diagrams of example engine systems according to the present disclosure;

FIG. 2 is a functional block diagram of an example engine control system according to the present disclosure;

FIG. 3 is a functional block diagram of an example exhaust gas recirculation (EGR) flowrate determination module according to the present disclosure; and

FIG. 4 is a flowchart depicting an example method of determining an EGR mass flowrate according to the present disclosure.

### DETAILED DESCRIPTION

An engine combusts an air/fuel mixture within cylinders to produce drive torque for a vehicle. The engine outputs exhaust resulting from combustion to an exhaust system. An exhaust gas recirculation (EGR) system re-circulates exhaust from the exhaust system back to an intake manifold.

An engine control module (ECM) may control the EGR system based on re-circulating exhaust back to the intake manifold at a target mass flow rate. For example, the ECM may regulate opening of an EGR valve based on a difference between the target mass flow rate and a mass flow rate of exhaust being recirculated back to the intake manifold.

The ECM according to the present disclosure estimates the mass flow rate of exhaust gas being recirculated back to the intake manifold. The ECM determines partial pressures of oxygen in the intake manifold and in the exhaust system based on measurements of oxygen sensors located in the intake manifold and in the exhaust system, respectively.

The ECM determines an intake oxygen concentration based on the partial pressure of oxygen in the intake manifold. The ECM corrects the intake oxygen concentration based on a pressure within the intake manifold. The ECM determines an exhaust oxygen concentration based on the partial pressure of oxygen in the exhaust system. The ECM may also correct the exhaust oxygen concentration based on a pressure in the exhaust system.

The ECM determines the mass flow rate of exhaust gas being recirculated back to the intake manifold based on the intake and exhaust oxygen concentrations. The determined mass flow rate of exhaust gas is accurate throughout a range of possible engine delta pressures, including low engine delta pressures. Engine delta pressure may refer to a difference between a pressure in the intake manifold and a pressure in the exhaust system.

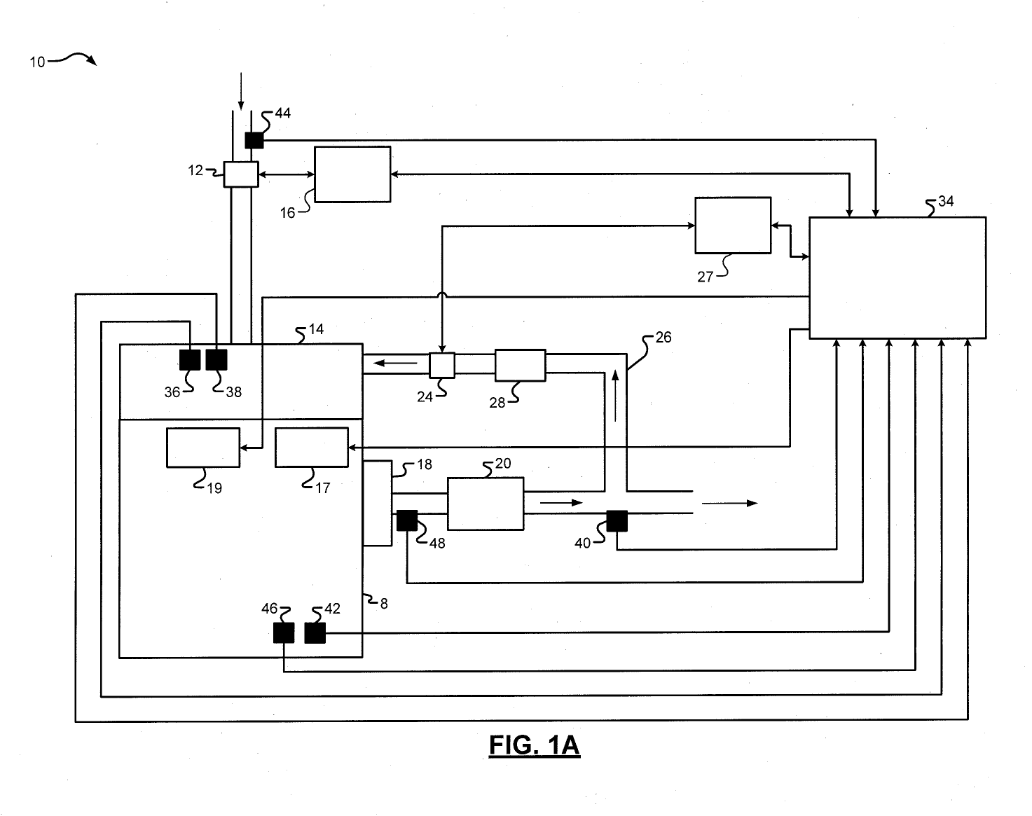

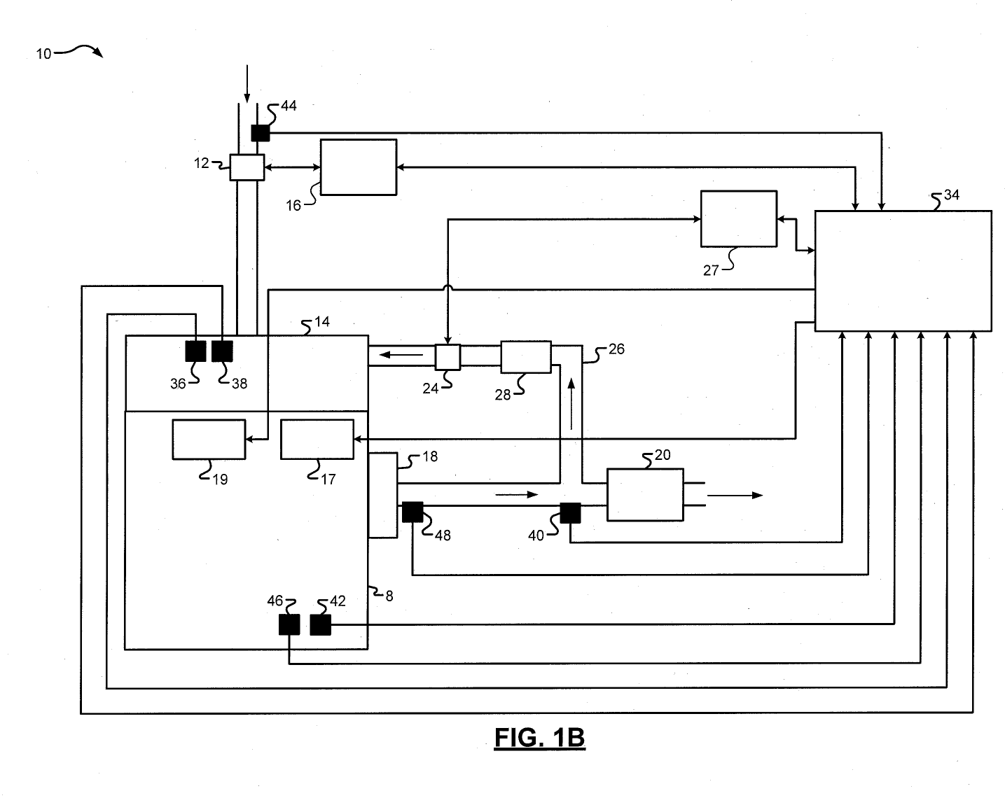

Referring now to FIGS. 1A and 1B, functional block diagrams of examples of an engine system 10 is presented. While the engine system 10 will be discussed in terms of a spark ignition engine system, the present application is also applicable to other types of engine systems including compression ignition engine systems and hybrid engine systems.

Air is drawn into an engine 8 via an intake system. The intake system includes a throttle valve 12 and an intake manifold 14. The throttle valve 12 regulates airflow into the intake manifold 14. A throttle actuator module 16 controls actuation of the throttle valve 12. The engine 8 combusts an air/fuel mixture within cylinders of the engine 8. A fuel system 17 selectively injects fuel into the engine 8. An ignition system 19 selectively provides spark to the engine 8 for combustion.

Combustion of the air/fuel mixture drives a crankshaft and produces exhaust. The engine 8 outputs the exhaust to an exhaust manifold 18. A catalyst 20 receives the exhaust from the exhaust manifold 18 and reacts with various components of the exhaust. For example only, the catalyst 20 may include a three-way catalyst (TWC), a catalytic converter, or another suitable type of catalyst.

An EGR system selectively recirculates a portion of the exhaust back to the intake system. While recirculation of exhaust back to the intake manifold 14 is shown and will be discussed, exhaust can be recirculated back to other locations in the intake system (upstream of the intake oxygen sensor, which is introduced below). The EGR system includes an EGR valve 24 and an EGR conduit 26. Operation of the engine 8 creates a vacuum (low pressure relative to ambient pressure) within the intake manifold 14. Opening the EGR valve 24 allows exhaust to be recirculated back to the intake manifold 14. An EGR actuator module 27 may control actuation of the EGR valve 24.

The EGR system may also include an EGR cooler 28 that cools exhaust as the exhaust flows through the EGR cooler 28 on its way back to the intake manifold 14. In various implementations, the EGR system may further include a cooler bypass system that can be controlled to allow exhaust to bypass the EGR cooler 28 on its way back to the intake manifold 14. The exhaust may be recirculated back to the intake manifold 14 from downstream of the catalyst 20 as shown in FIG. 1A. As shown in FIG. 1B, the exhaust may alternatively be recirculated back to the intake manifold 14 from upstream of the catalyst 20.

An engine control module (ECM) 34 regulates operation of the engine system 10. For example, the ECM 34 may control opening of the throttle valve 12 via the throttle actuator module 16, opening of the EGR valve 24 via the EGR actuator module 27, fuel injection amount and timing via the fuel system 17, and spark timing via the ignition system 19. The ECM 34 may also control operation intake and exhaust valve actuators, boost devices, and/or one or more other suitable engine actuators. While no boost devices (e.g., one or more turbochargers) are shown, the present application is applicable to high pressure and low pressure loop configurations where one or more turbochargers are implemented.

The ECM 34 communicates with various sensors, such as a manifold absolute pressure (MAP) sensor 36, an intake oxygen (IO) sensor 38, and an exhaust oxygen (EO) sensor 40. The ECM 34 also communicates with an engine speed sensor 42, a mass air flow (MAF) sensor 44, an engine coolant temperature sensor 46, an exhaust temperature sensor 48, and/or one or more other suitable sensors.

The MAP sensor 36 generates a MAP signal indicating an absolute pressure in the intake manifold 14. The engine speed sensor 42 generates a signal based on rotation of the crankshaft. An engine speed, in revolutions per minute (RPM), can be generated based on the rotation of the crankshaft.

The IO sensor 38 generates an IO signal (e.g., current or voltage) that corresponds to a partial pressure of oxygen within the intake manifold 14. The EO sensor 40 generates an EO signal (e.g., current or voltage) that corresponds to a partial pressure of oxygen in the exhaust. The EO sensor 40 is located such that it generates the EO signal based on the exhaust that is recirculated back to the engine 8. For example, the EO sensor 40 is located upstream of the catalyst 20 when the exhaust is recirculated from upstream of the catalyst 20 as shown in FIG. 1A. When the exhaust is recirculated from downstream of the catalyst 20, as shown in FIG. 1B, the EO sensor 40 is located downstream of the catalyst 20.

The engine coolant temperature sensor 46 generates a coolant temperature signal indicating an engine coolant temperature. The exhaust temperature sensor 48 generates an exhaust temperature signal indicating the exhaust temperature prior to the exhaust flowing through the EGR cooler 28 and/or other treatment devices.

The MAF sensor 44 generates a MAF signal indicating mass flow rate of air into the intake manifold 14. The ECM 34 determines an engine load. For example only, the ECM 34 may determine the engine load based on an engine output torque and/or a fueling rate of the engine 8. The fueling rate may be, for example, an amount (e.g., volume or mass) of fuel per combustion event.

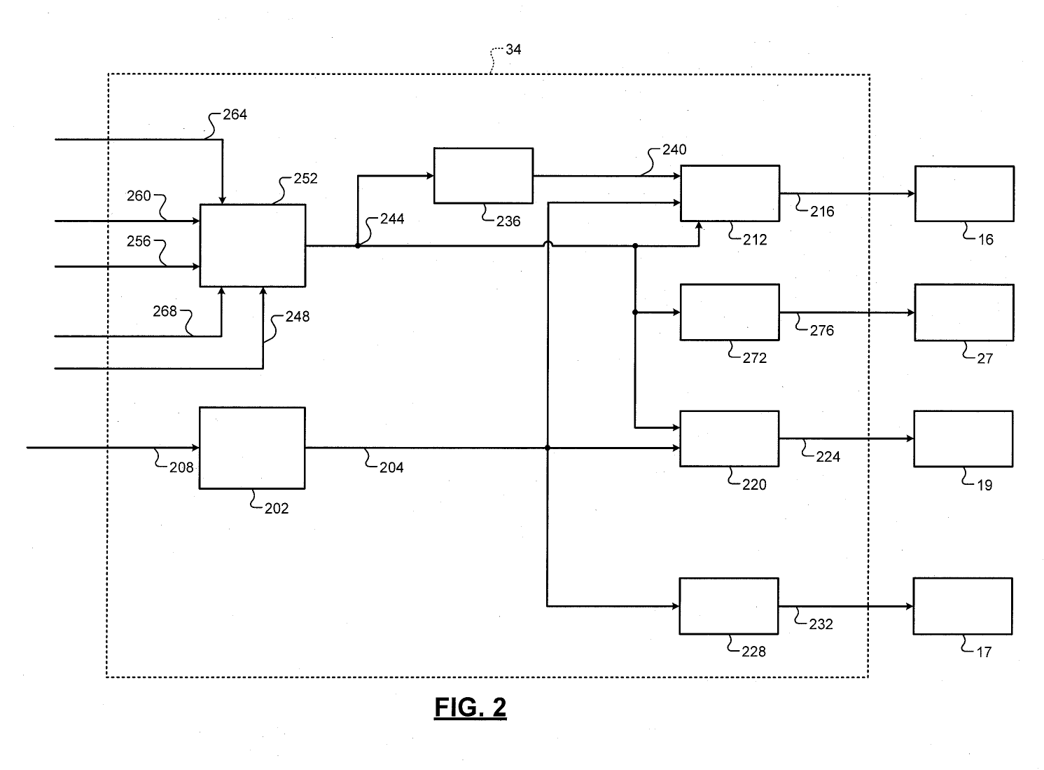

Referring now to FIG. 2, a functional block diagram of an example implementation of the ECM 34 is presented. A driver torque module 202 may determine a driver torque request 204 based on one or more driver inputs 208, such as an accelerator pedal position, a brake pedal position, a cruise control input, and/or one or more other suitable driver inputs. One or more engine actuators may be controlled based on the driver torque request 204 and/or one or more other torque requests.

For example, a throttle control module 212 may determine a desired throttle opening 216 based on the driver torque request 204. The throttle actuator module 16 may adjust opening of the throttle valve 12 based on the desired throttle opening 216. A spark control module 220 may determine a desired spark timing 224 based on the driver torque request 204. The ignition system 19 may generate spark based on the desired spark timing 224. A fuel control module 228 may determine one or more desired fueling parameters 232 based on the driver torque request 204. For example, the desired fueling parameters 232 may include fuel injection timing and amount. The fuel system 17 may inject fuel based on the desired fueling parameters 232.

A torque estimation module 236 may estimate a torque output of the engine 8. The estimated torque output of the engine 8 will be referred to as an estimated torque 240. The throttle control module 212 may use the estimated torque 240 to perform closed-loop control of one or more engine air flow parameters, such as throttle area, MAP, and/or one or more other suitable air flow parameters. The throttle control module 212 may adjust the desired throttle opening 216 based on the estimated torque 240.

The torque estimation module 236 may determine the estimated torque 240 using a torque relationship. For example, the torque estimation module 236 may determine the estimated torque 240 using the relationship:

T=f(APC, S, I, E, AF, OT, #, EGR) (1)

where torque (T) is the estimated torque 240 and is a function of air per cylinder (APC), spark advance/timing (S), intake opening timing and duration (I), exhaust opening timing and duration (E), air/fuel ratio (AF), oil temperature (OT), number of activated cylinders (#), and EGR mass flowrate (EGR) 244. This relationship may be modeled by an equation and/or may be stored in the form of a mapping (e.g., look up table). The APC may be determined based on measured MAF and current engine speed.

The spark control module 220 may determine the desired spark timing 224 using a spark relationship. The spark relationship may be based on the torque relationship above, inverted to solve for desired spark timing. For example only, for a given torque request (T_{des}), the spark control module 220 may determine the desired spark timing 224 using a spark relationship:

S_{des}=f⁻¹(T_{des}, APC, I, E, AF, OT, #, EGR) (2)

The spark relationship may be embodied as an equation and/or as a lookup table. The air/fuel ratio (AF) may be the actual air/fuel ratio, for example, as reported by the fuel control module 228.

Engine delta pressure refers to a difference between exhaust pressure and intake pressure (e.g., exhaust pressure minus intake pressure). For example, engine delta pressure may refer to a difference between a pressure in the intake manifold 14 and a pressure where exhaust is recirculated from. For example, the engine delta pressure may refer to a difference between a pressure at the IO sensor 38 and a pressure at the EO sensor 40.

When the engine delta pressure is low, accurately determining the EGR mass flowrate 244 may be difficult. The engine delta pressure may be low, for example, when an engine load 248 is greater than a predetermined load. The engine load 248 may be expressed as a percentage (%) of a maximum value of the engine load 248 (100%), and the predetermined load may be approximately 35 percent or another suitable value. As stated above, the engine load 248 may be determined based on an engine output torque and/or the fueling rate of the engine 8. Additionally or alternatively, the engine load 248 may be determined based on one or more other parameters, such as the APC, the MAP, the MAF, etc.

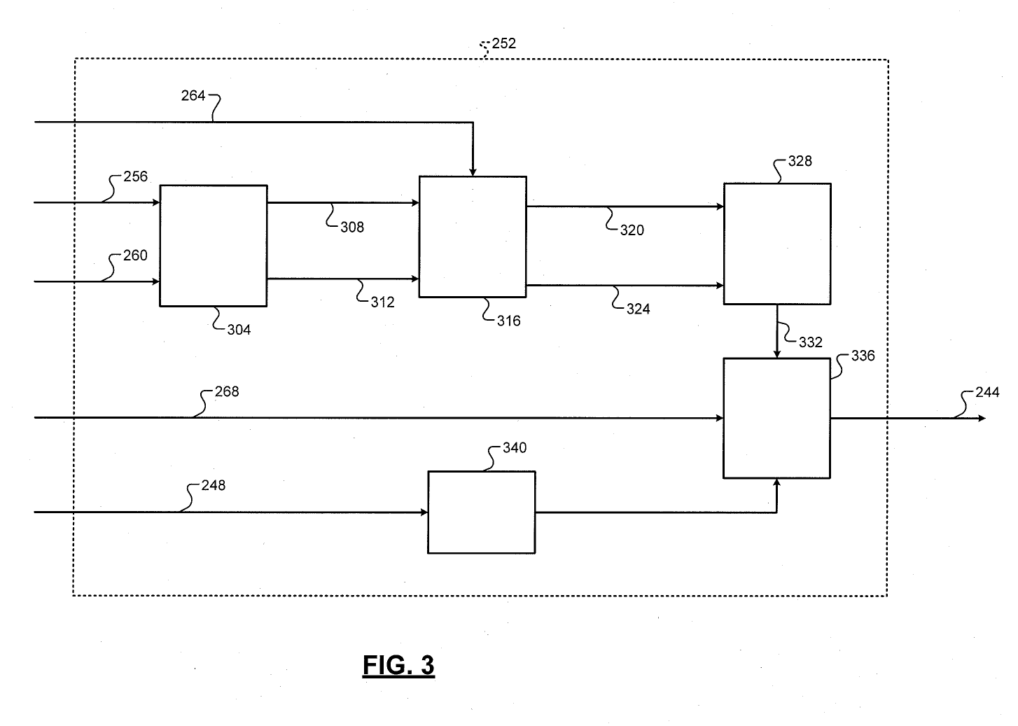

An EGR flowrate determination module 252 (see also FIG. 3) determines the EGR mass flow rate (EGR) 244. The EGR flowrate determination module 252 determines intake and exhaust partial pressures of oxygen based on the IO and EO signals 256 and 260, respectively.

The EGR flowrate determination module 252 determines intake and exhaust oxygen concentrations based on the intake and exhaust oxygen partial pressures, respectively. The EGR flowrate determination module 252 compensates the intake oxygen concentration based on MAP 264 measured using the MAP sensor 36. The EGR flowrate determination module 252 may also compensate the exhaust oxygen concentration based on a pressure at the location of the EO sensor 40.

The EGR flowrate determination module 252 determines a fraction of the combined air/exhaust flow through the engine 8 that is exhaust that was recirculated back to the engine 8 by the EGR system. The fraction will be referred to as the EGR fraction. The EGR flowrate determination module 252 determines the EGR fraction based on the intake and exhaust oxygen concentrations. The EGR flowrate determination module 252 determines the EGR mass flowrate 244 based on MAF 268 measured using the MAF sensor 44 and the EGR fraction.

As stated above, the throttle control module 212 may determine the desired throttle opening 216 based on the estimated torque 240, and the estimated torque 240 may be determined based on the EGR mass flowrate 244. One or more other engine actuators may be controlled based on the EGR mass flowrate 244. For example, as also stated above, the spark control module 220 may determine the desired spark timing 224 based on the EGR mass flowrate 244. Additionally, an EGR control module 272 may determine a desired EGR opening 276 based on the EGR mass flowrate 244. The EGR actuator module 27 may control opening of the EGR valve 24 based on the desired EGR opening 276. One or more other engine actuators may additionally or alternatively be actuated based on the EGR mass flowrate 244.

Referring now to FIG. 3, a functional block diagram of an example implementation of the EGR flowrate determination module 252 is presented. A partial pressure determination module 304 may determine an intake oxygen (IO) partial pressure 308 (e.g., in Pascal or Pa) based on the IO signal 256 from the IO sensor 38. The partial pressure determination module 304 may also determine an exhaust oxygen (EO) partial pressure 312 (e.g., in Pa) based on the EO signal 260 from the EO sensor 40.

The IO signal 256 and the EO signal 260 may be based on current flow through the IO sensor 38 and current flow through the EO sensor 40, respectively. The current through the IO sensor 38 and the current through the EO sensor 40 may be referred to as pumping currents. The partial pressure determination module 304 may determine the IO partial pressure 308 and the EO partial pressure 312 using one or more functions and/or mappings that relate the IO signal 256 and the EO signal 260 to the IO partial pressure 308 and the EO partial pressure 312, respectively.

A concentration determination module 316 determines an IO concentration 320 based on the IO partial pressure 308. The IO concentration 320 may be expressed as a percentage (by volume) of oxygen in the gas (air and/or exhaust) present at the location of the IO sensor 38. The concentration determination module 316 also determines an EO concentration 324 based on the EO partial pressure 312. The EO concentration 324 may be expressed as a percentage (by volume) of oxygen in the gas present at the location of the EO sensor 40. For example only, ideal dry air may have a percentage of oxygen by volume of approximately 20.9%. The percentage of oxygen by volume of air may be a value between 19.5 and 20.9 depending on humidity and barometric conditions and may be a calibrated value.

The concentration determination module 316 may determine the EO concentration 324, for example, using one or more functions and/or mappings that relate the EO partial pressure 312 to the EO concentration 324. The concentration determination module 316 may correct the IO concentration 320 to compensate for the MAP 264. For example only, the concentration determination module 316 may determine the IO concentration 320 using one or more functions and/or mappings that relate the IO partial pressure 308 and the MAP 264 to the IO concentration 320.

In various implementations, the concentration determination module 316 may determine a correction (not shown) based on the MAP 264 and determine an uncompensated IO concentration (not shown) based on the IO partial pressure 308. The concentration determination module 316 may determine the uncompensated 10 concentration, for example, using one or more functions or mappings that relate the IO partial pressure 308 to the uncompensated IO concentration. The concentration determination module 316 may determine the correction, for example, using one or more functions or mappings that relate the MAP 264 to the correction. The concentration determination module 316 may determine the IO concentration 320 based on the correction and the uncompensated IP concentration. The concentration determination module 316 may, for example, set the IO concentration 320 equal to one of a product and a sum of: the uncompensated IO concentration; and the correction. While not shown, in various implementations, similar operations may be performed based on a pressure at the EO sensor 40 to ensure that the EO concentration 324 is determined as a function of the pressure at the EO sensor 40.

A fraction determination module 328 determines an EGR fraction 332. The EGR fraction 332 may be the portion of the total gas (air and exhaust) flow through the engine 8 that is recirculated exhaust gas. The fraction determination module 328 determines the EGR fraction 332 based on the IO concentration 320 and the EO concentration 324. The fraction determination module 328 may determine the EGR fraction 332, for example, based on one or more functions and/or mappings that relate the IO concentration 320 and the EO concentration 324 to the EGR fraction 332.

For example only, the fraction determination module 328 may determine the EGR fraction 332 using the equation:

$$Fraction = \frac{AOC - IOC}{AOC - EOC} ,$$

where Fraction is the EGR fraction 332, AOC is the oxygen concentration (by volume) of ambient air, IOC is the IO concentration 320, and EOC is the EO concentration 324. The EGR fraction 332 can be converted to a percentage by multiplying a result of the above by one-hundred. The AOC may be set to a predetermined value in various implementations, such as 21 or 20.9. When fueling of the engine 8 is approximately stoichiometric or rich, the EO concentration 324 will be approximately zero. Approximately zero may mean zero or close enough to zero such that, relative to the AOC and the IO concentration 320, the EO concentration 324 can be considered zero. When fueling of the engine 8 is lean, the EO concentration 324 will be greater than zero, and the EO concentration 324 may increase as fueling becomes more lean. In engine systems where the engine 8 is not operated with lean fueling, the EO sensor 40 may be omitted, and the EO concentration 324 may be set to zero.

A flowrate determination module 336 determines the EGR mass flowrate 244 based on the EGR fraction 332 and the MAF 268. The flowrate determination module 336 may determine the EGR mass flowrate 244 using one or more functions and/or mappings that relate the EGR fraction 332 and the MAF 268 to the EGR mass flowrate 244. For example only, the flowrate determination module 336 may determine the EGR mass flowrate 244 using the equation:

$${\dot{m}}_{EGR} = \frac{Fraction}{1 - Fraction} * {\dot{m}}_{MAF} ,$$

where \dot{m}_{EGR} is the EGR mass flowrate 244, Fraction is the EGR fraction 332, and \dot{m}_{MAF} is the MAF 268. The EGR mass flowrate 244 may be accurate throughout the range of possible engine delta pressures, including low engine delta pressures.

Optionally, an enabling/disabling module 340 may selectively enable and disable the flowrate determination module 336. The enabling/disabling module 340 may disable the flowrate determination module 336 when the engine delta pressure is not low and may enable the flowrate determination module 336 when the engine delta pressure is low. In this manner, the EGR mass flowrate 244 may be determined as described above when the engine delta pressure is low. A comparison of the engine load 248 and a predetermined load may be indicative of whether the engine delta pressure is low. For example only, the engine delta pressure may be deemed low when the engine load 248 is greater than a predetermined load, such as approximately 35% or another suitable value.

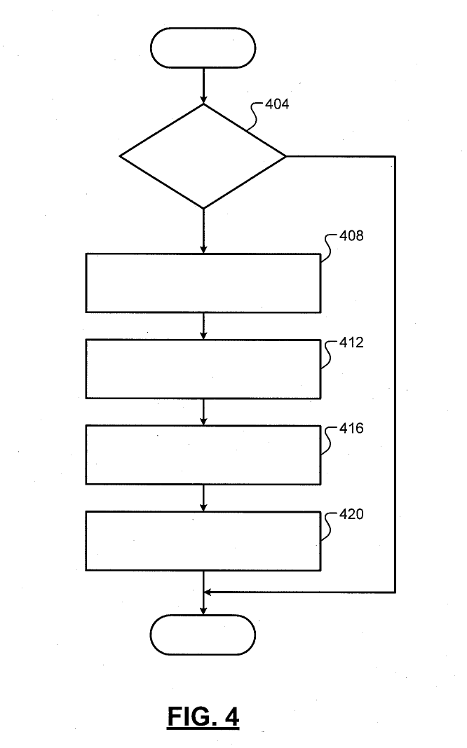

Referring now to FIG. 4, a flowchart depicting an example method of determining the EGR mass flowrate 244 is presented. In various implementations, control may begin with 404 where control determines whether the engine delta pressure is low. For example only, control may determine whether the engine load 248 is less than the predetermined load. If true, control may continue with 408. If false, control may end.

In other implementations, control may begin with 408. At 408, control determines the IO partial pressure 308 as a function of the IO signal 256. Control also determines the EO partial pressure 312 as a function of the EO signal 260 at 408. Control continues with 412.

At 412, control determines the IO concentration 320 and the EO concentration 324. Control determines the IO concentration 320 based on the IO partial pressure 308 and the MAP 264. Control determines the ED concentration 324 based on the EO partial pressure 312. Control may determine the EO concentration further based on the pressure at the location of the EO sensor 40. Control continues with 416.

Control determines the EGR fraction 332 at 416. Control determines the EGR fraction 332 based on the IO concentration 320 and the EO concentration 324. Control determines the EGR fraction 332 further based on the oxygen concentration of the ambient air. The oxygen concentration of the ambient air may be a predetermined value (e.g., 21 or 20.9) or may be a variable value and may be set based on one or more received parameters. Control may determine the EGR fraction 332, for example, using the equation:

$$Fraction = \frac{AOC - IOC}{AOC - EOC} ,$$

where Fraction is the EGR fraction 332, AOC is the oxygen concentration (by volume) of ambient air, IOC is the IO concentration 320, and EOC is the EO concentration 324. Control continues with 420.

At 420, control determines the EGR mass flowrate 244. Control determines the EGR mass flowrate 244 based on the EGR fraction 332 and the MAF 268. Control may determine the EGR mass flowrate 244, for example, using the equation:

$${\dot{m}}_{EGR} = \frac{Fraction}{1 - Fraction} * {\dot{m}}_{MAF} ,$$

where \dot{m}_{EGR} is the EGR mass flowrate 244, Fraction is the EGR fraction 332, and \dot{m}_{MAF} is the MAF 268. The EGR mass flowrate 244 is suitably accurate, even when the engine delta pressure is low.

Control may selectively adjust one or more engine operating parameters based on the EGR mass flowrate 244. For an example only, the estimated torque 240 may be determined based on the EGR mass flowrate 244, and one or more engine actuators may be adjusted based on the estimated torque 240, such as the throttle valve 12. For another example only, opening of the EGR valve 24 may be adjusted based on the EGR mass flowrate 244, for example, to achieve a target EGR mass flowrate. For another example only, spark timing may be adjusted based on the EGR mass flowrate 244. One or more other engine operating parameters may additionally or alternatively be adjusted based on the EGR mass flowrate 244.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. An engine control system for a vehicle, comprising:
a partial pressure determination module that:
determines a first partial pressure of oxygen in an intake manifold of an engine based on an output of a first oxygen sensor measuring oxygen in the intake manifold; and
determines a second partial pressure of oxygen in an exhaust system based on an output of a second oxygen sensor measuring oxygen in the exhaust system;
a concentration determination module that:
determines a concentration of oxygen in the intake manifold based on the first partial pressure and an intake manifold; and
determines a concentration of oxygen in the exhaust system based on the second partial pressure;
a flowrate determination module that determines a mass flowrate of exhaust gas recirculation (EGR) based on the concentration of oxygen in the intake manifold and the concentration of oxygen in the exhaust system; and
an actuator control module that controls an engine operating parameter based on the mass flowrate of EGR.

2. The engine control system of claim 1 wherein the concentration determination module determines the concentration of oxygen in the exhaust system further based on a pressure at the second oxygen sensor.

3. The engine control system of claim 1 wherein the concentration determination module determines the concentration of oxygen in the intake manifold using one of a function and a mapping that relates the first partial pressure and the intake manifold pressure to the concentration of oxygen in the intake manifold.

4. The engine control system of claim 1 further comprising a fraction determination module that determines an EGR fraction based on the concentration of oxygen in the intake manifold, the concentration of oxygen in the exhaust system, and a concentration of oxygen in ambient air,
wherein the flowrate determination module determines the mass flowrate of EGR based on the EGR fraction.

5. The engine control system of claim 4 wherein the fraction determination module sets the EGR fraction equal to a first value divided by a second value,
wherein the first value is equal to the concentration of oxygen in ambient air minus the concentration of oxygen in the intake manifold, and
wherein the second value is equal to the concentration of oxygen in ambient air minus the concentration of oxygen in the exhaust system.

6. The engine control system of claim 4 wherein the flowrate determination module determines the mass flowrate of EGR further based on a mass flowrate of air into the engine.

7. The engine control system of claim 6 wherein the flowrate determination module sets the mass flowrate of EGR equal to a third value divided by a fourth value,
wherein the third value is equal to a product of the EGR fraction and the mass flowrate of air into the engine, and
wherein the fourth value is equal to one minus the EGR fraction.

8. The engine control system of claim 1 further comprising a torque estimation module that estimates a torque output of the engine based on the mass flowrate of EGR,
wherein the actuator control module selectively adjusts opening of a throttle valve based on the torque output of the engine.

9. The engine control system of claim 1 wherein the actuator control module selectively adjusts a spark timing based on the mass flowrate of EGR.

10. The engine control system of claim 1 wherein the actuator control module selectively adjusts opening of an EGR valve based on the mass flowrate of EGR.

11. An engine control method for a vehicle, comprising:
determining a first partial pressure of oxygen in an intake manifold of an engine based on an output of a first oxygen sensor measuring oxygen in the intake manifold;
determining a second partial pressure of oxygen in an exhaust system based on an output of a second oxygen sensor measuring oxygen in the exhaust system;
determining a concentration of oxygen in the intake manifold based on the first partial pressure and an intake manifold;
determining a concentration of oxygen in the exhaust system based on the second partial pressure;
determining a mass flowrate of exhaust gas recirculation (EGR) based on the concentration of oxygen in the intake manifold and the concentration of oxygen in the exhaust system; and
controlling an engine operating parameter based on the mass flowrate of EGR.

12. The engine control method of claim 11 further comprising determining the concentration of oxygen in the exhaust system further based on a pressure at the second oxygen sensor.

13. The engine control method of claim 11 further comprising determining the concentration of oxygen in the intake manifold using one of a function and a mapping that relates the first partial pressure and the intake manifold pressure to the concentration of oxygen in the intake manifold.

14. The engine control method of claim 11 further comprising:
determining an EGR fraction based on the concentration of oxygen in the intake manifold, the concentration of oxygen in the exhaust system, and a concentration of oxygen in ambient air; and
determining the mass flowrate of EGR based on the EGR fraction.

15. The engine control method of claim 14 further comprising setting the EGR fraction equal to a first value divided by a second value,
wherein the first value is equal to the concentration of oxygen in ambient air minus the concentration of oxygen in the intake manifold, and
wherein the second value is equal to the concentration of oxygen in ambient air minus the concentration of oxygen in the exhaust system.

16. The engine control method of claim 14 further comprising determining the mass flowrate of EGR further based on a mass flowrate of air into the engine.

17. The engine control method of claim 16 further comprising setting the mass flowrate of EGR equal to a third value divided by a fourth value,
wherein the third value is equal to a product of the EGR fraction and the mass flowrate of air into the engine, and
wherein the fourth value is equal to one minus the EGR fraction.

18. The engine control method of claim 11 further comprising:
estimating a torque output of the engine based on the mass flowrate of EGR; and
selectively adjusting opening of a throttle valve based on the torque output of the engine.

19. The engine control method of claim 11 further comprising selectively adjusting a spark timing based on the mass flowrate of EGR.

20. The engine control method of claim 11 further comprising selectively adjusting opening of an EGR valve based on the mass flowrate of EGR.
